(19) United States
(12) Patent Application Publication
(10) Pub. No.: US 2008/0028865 A1
(43) Pub. Date: Feb. 7, 2008

(54) Portable Deflection Instrument for Testing Installed Planks

(76) Inventors: David H. Steele, Jackson, MI (US); James N. Valentine, River Junction, MI (US); Thomas K. MacKinnon, Ann Arbor, MI (US); Robert W. Werner, Howell, MI (US); David Stucky, Grass Lake, MI (US); Greg Quist, Jackson, MI (US)

Correspondence Address: DUANE MORRIS, LLP;IP DEPARTMENT, 30 SOUTH 17TH STREET, PHILADELPHIA, PA, 19103-4196, US

(21) Appl. No.: 11/462,754

(22) Filed: Aug. 7, 2006

(51) Int. Cl. G01N 3/20

(52) U.S. Cl. 73/849

(57) ABSTRACT

The deflection of decking planks under load is tested using a portable deflection measurement instrument, after installation of the planks over spaced joists. The instrument has a bridge on support legs spaced to rest on the deck at points apart from a span between joists of one or more planks to be tested. The legs can rest on planks laterally adjacent to the plank(s) under test, so the bridge straddles over the plank, or the bridge can be cantilevered or can rest on the tested plank but at points beyond the span to be tested. A contact foot or tup is movably mounted on the bridge and coupled to a platform or similar receptacle by which weight is applied to the plank. The resulting displacement between rest and loaded states is measured using a distance scale, and applied as a function of the span length and loading criteria to assess the deck structure. In one embodiment, the bridge has handle rails whereby a user moves and places the bridge, and which rails assist in permitting the user to step, kneel or otherwise apply his/her body weight against the plank via the tup.

### BACKGROUND OF THE INVENTION

1. Field of the Invention

The invention concerns apparatus and methods for assessing the structural strength of elongated building elements after installation, especially polymer or composite planks supported on spaced joists to surface a deck.

2. Prior Art

It is known to test the strength of elongated structural elements such as planks, beams and the like, by assessing the extent to which the elements resist bending under force. Such testing is typically a grading or quality assurance step associated with production. The testing may involve supporting the element at one point (or at two spaced points) and applying a mechanical load laterally at a distance from the support(s). The deflection of the element at the point of application of the load, or at another point spaced from the support(s), is noted as a measure of the extent to which the elongated element was caused to bend.

Testing in this way preferably is nondestructive, involving bending to an extent that does not cause permanent deformation or lead to breakage. The testing step can be incorporated into a production line, particularly in connection with production of composite products. A representative sample of products can be tested on a free standing measurement jig, or every unit of product (e.g., every plank) might be passed through an automated testing station, for example comprising rollers defining an S-shaped path through which a nominally planar product is passed. Force applied to the rollers, as the planar product is bent in moving along the path, is a function of the stiffness of the product (resistance to bending). The stiffness of the product may be correlated to the strength that the product will contribute to a structure in which the product is assembled. The product might be natural wood or a polymer or a composite and might be dimensions more or less as a sheet or as a plank or as a beam, etc.

During production, the products are all the same nominal size and are unencumbered, so that it is possible to subject the products to a standardized test along a conveyor path, and to obtain meaningful and repeatable results because a comparable test is being conducted on comparable structural elements. However, after the elements are cut to size and assembled into a structure, typically with nails or screws or other fasteners placed at various strategic points, the possibility of testing is more problematic. This is one of the aspects of the present invention, which is particularly intended to enable in situ testing of structural elements including composite material planks that are already affixed in position.

In the construction of a deck, closely spaced planks are typically affixed by nails, screws and/or clips to widely spaced joists, with the planks being parallel and the joists being parallel. The planks and the joists are elongated in different directions, often perpendicularly. The planks are fastened to the joists where they cross. Typical planks are 5/4×6, 2×6 or 2×4 inches (although other sizes are possible). The planks are cut to different lengths as dictated by the perimeter of the deck area and the need to stagger end butt joints. Joists are typically 2-by lumber placed perpendicularly across supporting beams such as manufactured beam material or 2×8 or other stock, in single or sistered thicknesses. In addition, horizontal framing members may be included such as a header attached to the house or other associated building structure, skirt edges trimming the outermost joists, and end plates over the outer ends of the joists.

Building codes and manufacturers' instructions specify various requirements for the design of decks, for reasons of structural integrity and safety assuming nominal loading conditions and light or heavy duty activities for which the deck is expected to be used. The requirements also may vary between different situations, for example based on whether the deck is elevated or has an overhang or is attached to a building, etc. A maximum uniform live load for a composite material deck might be 100 lbs./sq.ft. to 200 lbs./sq.ft. The requirements include minimum dimensions and spacings for respective structural parts when used together.

One frequently encountered building standard is the “L/360” standard providing that the maximum deflection of any span of decking between stationary supports should be less than or equal to one-360^{th} of the distance between the supports. With due regard to the stiffness of the planks, the L/360 standard results in a minimum joist spacing for plank products of a given dimension and material composition.

If the planks are perpendicular to the joists and the joists are spaced at nominal 16″ spacing, then L/360= 16/360=about 0.044″. The required plank stiffness and/or strength might be derived from this relationship. However, assuming that the planks are to have a given thickness (which results in a given modulus of elasticity and a predetermined propensity to bending), the L/360 standard also can be met by adjusting the spacing of the joists. A relatively more bendable material will have less deflection under load if the joists are closely spaced and more deflection if the joists are widely spaced. It is generally desirable to use a plank thickness and joist frequency in combination to meet the required standard, rather than to use unnecessary additional material. The joist spacing and the plank material stiffness both need to be taken into account.

Complicating factors such as the extent to which the deck designer adheres to the manufacturer's recommendations, and accuracy of the installer in placing the joists, are such that in a given construction, one or more spans between joists may be longer than others. Another complicating factor is that if the planks run at an angle to the joists (i.e., other than perpendicular), the angle must be taken into account. For example, the span between supported points along planks at 30 degrees to parallel joists is twice the span between planks that are perpendicular to joists at the same spacing.

There also are inevitable variations in the stiffness of the material of the planks, whether the planks are natural, partly natural (composite) or wholly synthetic. For these reasons, it is sometimes necessary to determine after installation whether a construction (due the design and/or materials) meets the L/360 standard, and perhaps to take appropriate action to replace or reinforce parts where necessary.

### SUMMARY OF THE INVENTION

It is an object of the invention to facilitate deflection testing of loaded planks in installed decking structures, including but not limited to porch and patio type decks. Among other uses, the invention provides a method and apparatus conveniently to test whether deck structures meet acceptance criteria related to the maximum plank deflection permitted under load. One such criteria can be the L/360 standard, other static or dynamic loading criteria also being applicable. The invention accommodates testing using different loading criteria, i.e., different loading weights and different plank length spans.

The deflection of decking planks under load is tested using a portable deflection measurement instrument, after installation of the planks over spaced joists. The instrument has a bridge on support legs spaced to rest on the deck at points apart from a span between joists of one or more planks to be tested. The legs can rest on planks laterally adjacent to the plank(s) under test, so the bridge straddles over the plank, or the bridge can be cantilevered or can rest on the tested plank but at points beyond the span to be tested. A contact foot or tup is movably mounted on the bridge and coupled to a platform or similar receptacle by which weight is applied to the plank. The resulting displacement between rest and loaded states is measured using a distance scale, and applied as a function of the span length and loading criteria to assess the deck structure. In one embodiment, the bridge has handle rails whereby a user moves and places the bridge, and which rails assist in permitting the user to step, kneel or otherwise apply his/her body weight against the plank via the tup.

### BRIEF DESCRIPTION OF THE DRAWINGS

Certain embodiments of the invention are shown in the drawings as nonlimiting examples; however, reference should be made to the claims to define the scope of the invention. In the drawings,

FIG. 1 is a partial perspective view showing an embodiment of the test apparatus of the invention being placed to measure the deflection characteristics of an installed plank of a deck.

FIG. 2 is an elevation view, partly in section, showing the interaction of the apparatus of the invention with a deck plank during a deflection test.

FIG. 3 is a partly sectional elevation view corresponding to FIG. 2, but showing the inventive apparatus embodied with handles for manual manipulation and a weight platform shown supporting a human operator constituting the test weight.

FIG. 4 is a perspective view illustrating a span measurement tool according to the invention.

FIG. 5 is an exploded perspective assembly view showing a calibration fixture according to the invention.

FIG. 6 is an exploded perspective assembly view showing the respective elements of a practical embodiment of the test apparatus.

### DETAILED DESCRIPTION

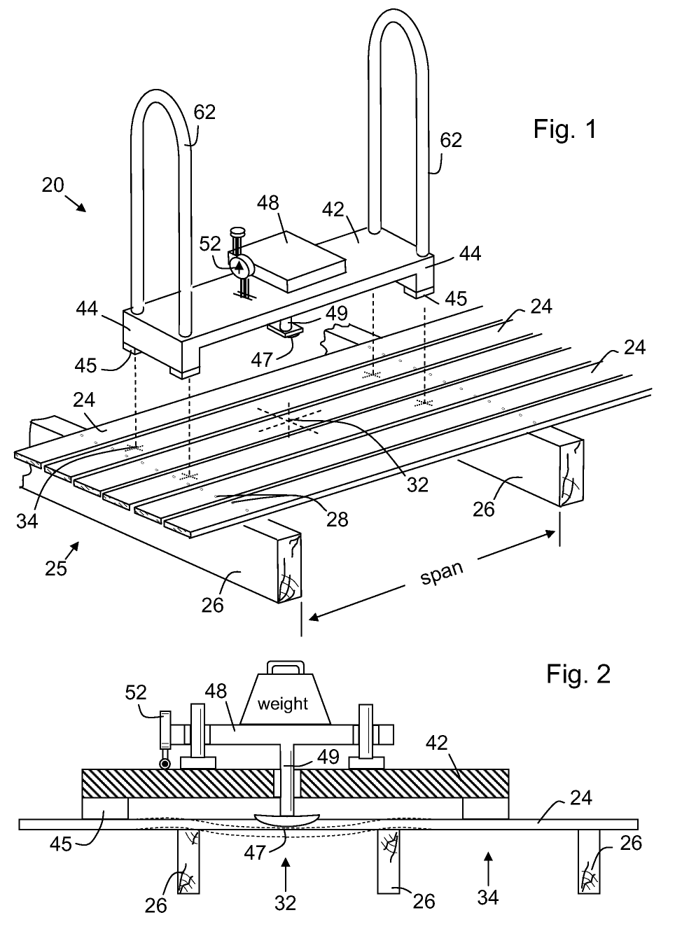

As shown in FIG. 1, the invention concerns an apparatus 20 used in a method for testing the extent to which planks 24 of an installed deck 25 are deflected when gravity-loaded by a weight bearing vertically downward. The apparatus can be used to verify the structural integrity of an installed deck 25, to verify the strength of individual planks 24, to assess whether or not it is appropriate to buttress deck structures in certain areas, such as high traffic areas, worn areas or areas subject to particular loading, etc.

A deck 25 of the type of structure shown typically comprises a plurality of parallel planks 24 forming a surface, mounted closely adjacent to one another and affixed to parallel underlying spaced joists 26 by fasteners 28 such as screws or nails. In many deck designs, particularly outdoor constructions that advantageously drain readily, admit air flow and are tolerant of thermal expansion, each of the planks 24 is spaced from adjacent planks by a narrow gap. Examples are decks that sometimes are used as porch or patio areas, swimming pool surrounds and the like. The joists 26 are in turn supported by beams on posts or on headers affixed to building panels, which are not shown.

In decks comprising planks spaced by a gap, each plank forms an independent load bearing member over the span between the joists 26 to which the planks are affixed. The joists 26 are typically parallel spaced members disposed at an angle to the planks 24, often perpendicularly, but possibly at an oblique angle. There are numerous varied arrangements of planks and joists possible, wherein the planks might be rectilinearly cut and/or equal in width, or otherwise shaped. There are any number of specific deck assemblies and related structures possible, wherein joists and/or planks may be equal or may vary in elevation or may be parallel or may be divergent at angles.

The invention is generally applicable to most or all arrangements wherein planks or plank-like members extend between spaced points of support such as joists, and over the span between such supports, the planks or other members need to support a static or live weight load. Various structures qualify but differ in one way or another from the conventional one-level parallel plank and perpendicular joist construction. A deck may have different grade levels. In stair steps, the stair treads function as load supporting planks at different elevations, carried on stringers that function as joists supporting the treads at spaced points. The deck planks may vary in orientation, possibly reflecting angles of joists that diverge (for example, in hexagonal or octagonal plank layouts), or possibly for other reasons such as to form a herringbone pattern.

When planks are oriented perpendicular to spaced parallel joists, the span of the planks between the joists is the minimum possible. If instead the planks are oriented at an angle, the span is longer according to the triangular geometry involved. For example, the span of a plank at 45 degrees to spaced parallel joists is equal to 1.414 times the perpendicular space between the joists (i.e., by the square root of two). The span of a plank at 30 degrees is twice the distance between the joists.

The extent to which a plank can support a weight is inversely related to the unsupported length that the plank spans. The plank functions as a resilient or elastic structure with a spring constant. At a distance from a point of support (or at a point between two spaced points of support), the plank can be deflected vertically from a rest plane by a distance that is related to the plank material stiffness (the dimensions and material modulus of elasticity), and the applied weight. This vertical deflection aspect can form the basis of a measurement for rating the load bearing capability of a plank or plank faced structure. Standards have been established with respect to the extent of vertical deflection permitted for deck planks when stressed by a load.

Other things being equal, a deck may adequately support a relatively greater load (more weight) without undue vertical deflection, either by substituting stronger and stiffer planks, or by spacing the joists more closely. Planks can be made stronger by using a stronger material or by making the planks thicker. It is generally undesirable to use planks that are thicker than necessary or joists that are more closely spaced than necessary, because these entail overuse of materials.

The present invention can be used with any flexing plank material, whether natural material such as wood or man made materials such as molded or extruded polymer material. The invention is particularly advantageous when used to assess the deflection characteristics of plank material made from composite material, such as a polymer matrix containing a particulate filler material, optionally provided with a wear resistant or wood simulative outer surface. Various products that simulate wood but are more durable and decay resistant are marketed. An example comprises wood flour filler in a polyvinyl chloride (PVC) matrix, optionally with a distinct outer surface (cap stock) comprising a different polymer material or a different mix of components.

Composite and synthetic planks and similar building materials are manufactured and engineered to meet specifications providing for a predetermined degree of flexibility, and often the resulting synthetic products are relatively flexible compared to similarly dimensioned wood. The characteristics of all planks of a given product description and size are more equal than is the case with natural wood. For these reasons, the deflection characteristics of synthetic and composite materials are important.

Natural and synthetic products both might be tested, classified for stiffness and sorted for flexibility and other characteristics. The repeatability of synthetic and partly synthetic (composite) materials is such that it is possible to remain close to the structural recommendations for decking construction, such as the recommended joist spacing under load, and thereby avoid unnecessary use of materials. However, some variation occurs among products. Also dimensional variations can occur during installation, including the spacing of joists, such that it is advantageous to test the deflection characteristics of planks after they are installed.

For this purpose, the apparatus shown in FIG. 1 comprises a self contained portable test fixture that can be deployed so as to interact with an installed plank 24 exclusively, namely by facilitating application of a test weight at a predetermined point between spaced support points along the plank, normally at a midpoint 32 between adjacent spaced joists 26.

The apparatus is arranged to act only on the plank 24 being tested, in that the apparatus is supported at points 34 other than the plank 24 being tested, and comprises a movable weight application mechanism whereby a weight can be applied to the plank 24. The vertical displacement of the mechanism is noted and determined to be the deflection of plank 24 under a load equal to the applied weight and over the span equal to the distance between support points, in this case joists 26.

The apparatus enables assessment of the deflection of decking planks 24, installed independently on deck 25, and carried on supports spaced by a measurable span. The apparatus as shown in FIG. 1 has a bridge member 42 generally forming a chassis. The understructure that forms the support for the bridge member has a set of support legs 44 arranged to carry the bridge member on the decking 25 apart from the plank 24 being tested. In the embodiment shown in FIG. 1, the legs 44 terminate in an array of spaced feet 45 located so that the feet can be placed on planks 24 that are not connected directly to the plank under test, e.g. adjacent planks 24. Therefore, the bridge member 42 is supported independently of the plank under test and remains stationary as the plank under test deflects with loading. It is unimportant whether or not the adjacent planks are deflected under the weight of the apparatus. These adjacent planks that support the apparatus on legs 44 and feet 45 only define a reference position from which deflection of the plank under test can be discerned when a loading weight is placed to load the plank under test alone.

The plank under test could be a single plank or a subset of two or more adjacent planks that are coupled together, or even two or more non-adjacent planks provided they are coupled together or are arranged such that the load weight can be applied to them as a structural unit. Thus, plural planks that are coupled by a batten (not shown) could be regarded as a structural unit. Plural planks that are not coupled together by structure of deck 25 could be regarded as a structural unit by providing a mechanism that applies the weight to the plural planks at the same time, thus being coupled by the mechanism that applies the weight. As another alternative, a panel that encompasses an area such as a square panel as opposed to an elongated plank, could be tested for deflection at a midpoint between supports at its corners, provided that the apparatus is supported independently of the panel during the testing.

The legs 44 and feet 45 hold at least part of the bridge member at a space over the plank to be tested (which as described can be any subset of planks that are coupled or can be loaded as a structural unit. A tup or contact member 47 is movably mounted on the bridge member 42, extending downward to the decking 25. The tup 47 is dimensioned exclusively to contact the subset of planks (one or more planks) that is to be tested for deflection under load.

For applying the test deflection load (not shown in FIG. 1), a mechanism is coupled to the tup 47 for selectively applying the desired loading force to the subset of planks 24 via the tup 47. Various force application techniques may be possible. The preferred technique is to provide a receptacle for a weight, in particular platform 48 in the embodiment of FIG. 1, and a connecting shaft 49 mounted slidably in the bridge member 42, coupling the test weight directly to the tup 47, for applying force to the decking plank(s) 24.

A distance displacement measurement scale or mechanism 52 is provided and is mounted between fixed and movable points on the bridge member 42, which remains stationary, and the tup or the mechanism associated with the tup, which moves vertically when a weight on the platform 48 or other receptacle loads the plank 24 and produces vertical downward deflection from a rest position. The operator either zeroes the measurement scale or mechanism 52 before applying the weight, or notes the scale reading before and after applying the weight. The measurement scale can be mounted on either the bridge 42 or the platform 48, provided that the relative movement of the other of the bridge 42 and platform 48 is measured.

The tup 47, platform 48 and sliding connecting shaft 49 comprises structures that have a nonzero weight, constituting a tare value. The tare weight should be small compared to the typical live load specification for the decking, typically 100 or 200 lbs. per square foot. The tare weight can be minimized by appropriate choices of materials and structures for the platform 48, shaft 49 and tup 47. For example, the platform 48 can be relatively thin steel plate or sheet metal. The shaft 49 can be a pipe section, etc. The tare weight can be partly offset by including a spring (not shown) such as a compression spring between the platform and the upper side of the bridge member 42.

If minimal, the tare weight can be ignored. Generally, even a significant tare weight can be taken into account by judging deflection as the difference in deflection between loading equal to the tare and loading equal to tare-plus the applied test weight, instead of between zero and the test weight.

FIG. 2 shows a similar but alternative embodiment wherein guide shafts are provided for obtaining a smooth application of force to the tup 47 via the platform 48, now shown with an applied weight, and via the slide shaft 49. In this embodiment, the measurement scale 52 comprises a distance feeler gauge. Such a gauge could be read out on mechanical dial. Alternatively, electrical position encoder can comprise a feeler gauge that resembles an inside-measurement caliper but also includes a position or displacement sensor coupled to a read-out. Other electrical, electromechanical and/or electronic alternatives include electrical distance measurement devices such as LVDTs (linearly variable differential transformers), an optical or sonic measurement device, etc., in each case coupled to a readout that is visible to the user for determining deflection distance. The measurement scale 52 is used to determine displacement from a reset no-load state to a loaded state. For example, two or more successive readings can be taken, one being a reference reading absent the loading force (weight on platform 48) and another being a deflection reading when the loading force is applied. The difference in said readings represents deflection of the subset of planks.

A particular measurement arrangement that has proved to be workable with the invention is the Mitutoyo Electronic Indicator, Model 543-453B, coupled to a Digimatic Gauge Counter, Model EC-10D. This arrangement has a zero to one inch measurement span. It reads out to a resolution of 0.0001 inch, with a nominal accuracy of ±0.00012 inch. Other specific measurement devices and techniques likewise can be used in this application.

In the embodiments of FIGS. 1 and 2, the legs 44 and feet 45 of the bridge member 42 laterally straddle the plank under test, in this case a single plank. In FIG. 1, the feet longitudinally are placed at support points 34 that are near to or directly over the underlying joists 26 on the planks adjacent to the plank under test. As shown in FIG. 2, this arrangement is not critical and the supports points 34 can be between joists 26 with the same effect. Apart from the weight applied via the tup 47, the apparatus does not load the plank under test because the apparatus is supported apart from the plank under test.

In FIGS. 1 and 2, the bridge member is supported on deck 25 but apart from the plank 24 under test. The bridge member straddles the plank under test and straddles the tup 47, which is manually located by the user at the midpoint 32 of the plank 24 between joists 26. The bridge member could alternatively be structured and/or supported in other and different ways that likewise support the apparatus substantially clear at least of the span of the plank 24 under test. For example, the bridge member could have a cantilevered support carrying shaft 49 and platform 48 off to one side. The bridge member could even be supported on the same plank as being tested, but along a span outside of a span being tested between two spaced adjacent joists. This latter technique may not be advantageous if downward deflection of the loaded plank within the span caused upward bowing of adjacent spans beyond the joists, where the apparatus is supported.

One advantageous aspect of the invention is that the apparatus is portable. The weight bearing platform and the mechanism for selectively applying the loading force to the planks is easily manipulated to deploy and locate the bridge member 42 in the correct position for temporary placement of a weight on the platform 48 and thereby to selectively apply the loading force via to plank 24 via the connection between the platform 48 and the tup 47, which is movable vertically relative to the bridge member 42. For this purpose, handles 62 are attached to the bridge member 42 and extend upwardly where they can be grasped to lift and move the apparatus.

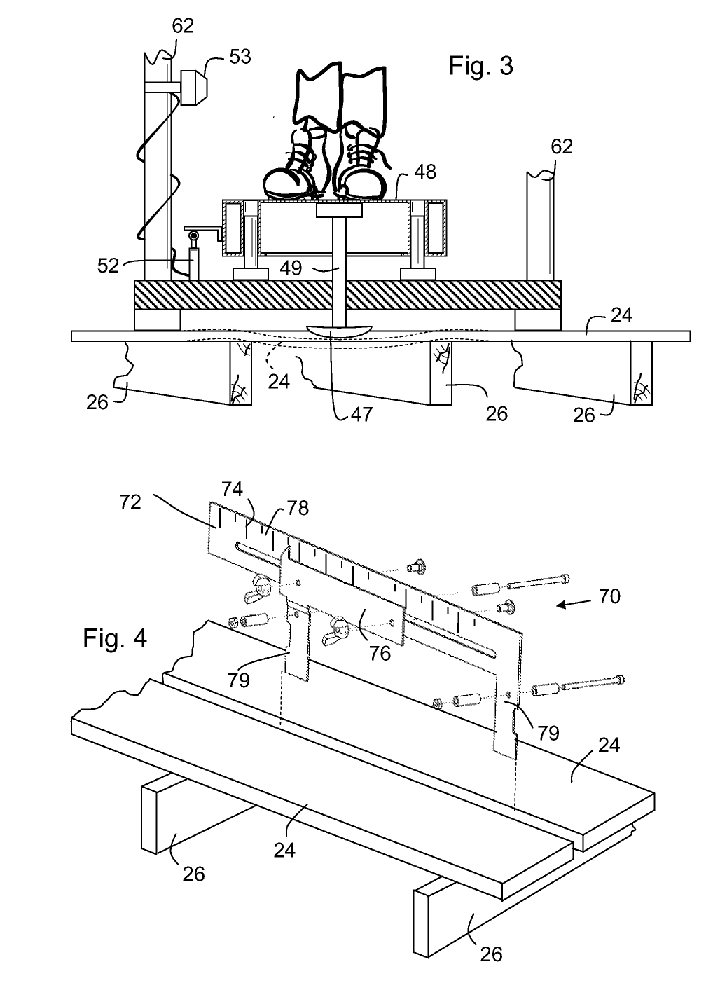

The apparatus might have a permanently attached weight on platform 48 or may receive a movable free weight as in FIG. 2. However this detracts from the portability and ease of use of the device, particularly because the weight used in testing may be substantial if testing is done at the specified free load weight of 100 or 200 lbs. over a square foot of plank area. However, it is an inventive aspect as shown in FIG. 3 that the source of the weight used in testing can be the body weight of the operator. The platform is configured to accommodate a human operator on the platform and a weight of said operator is applied as the loading force. This may be the full weight of the operator, by the operator stepping onto the platform 48 while holding the handles 62 as hand rails. Alternatively, the operator might kneel or sit on the platform with a similar effect.

In the embodiment shown in FIG. 1, at least one handhold, namely handle 62, is rigidly affixed to the bridge and extends upwardly, enabling the apparatus to be lifted manually and moved about. In use, the operator can carry the device to a deck, place the apparatus with the tup over a midpoint of a span on a plank to be tested and the legs supporting the apparatus at points apart from the plank. The operator notes the zero position of the measurement scale (or if an adjustment is provided resets the unloaded position as the zero position). The operator then steps up onto the platform, noting the resulting deflection distance between the unloaded (or tare loaded) and fully loaded state.

In order to facilitate moving the device around, the apparatus can be made from sheet metal and hollow parts. The feet 45 on one side or end of the device can be replaced with wheels (not shown) for rolling the apparatus into position like a shipping dolly. FIG. 3 also illustrates alternatives wherein the measurement scale device 52 is mounted on the bridge and senses the relative displacement of the platform, rather than vice versa. The measurement scale device 52 in this embodiment is coupled to an associated readout 53 that is visible to the operator.

The operator's weight is previously known. The length of the span of the tested plank 24 between joists 26 might be accepted as nominal. For example bracing (not shown) is sometimes used between joists (not shown) and could be noted as an indication of the joist spacing. More preferably, the distance between the joists 26 is measured because the joist spacing may not be nominal. A measurement of the span length is also useful if the planks 24 are oriented oblique to the joists 26 instead of perpendicularly, resulting in a span length that is determined by the oblique angles as well as the joist spacing. FIG. 4 shows a convenient span measurement tool 70 having a fixed rule 72 with graduation marks 74, a movable slide 76 with a pointer 78 that indicates a point on the graduations. These relatively slidable rule and slide parts each have a feeler end 79 that can be slipped through the slot between adjacent planks 24 and spread to where the feeler ends 79 abut against the joists 26 along a line parallel to the planks 24, being matched to the oblique angle by placement in the slot between planks 24.

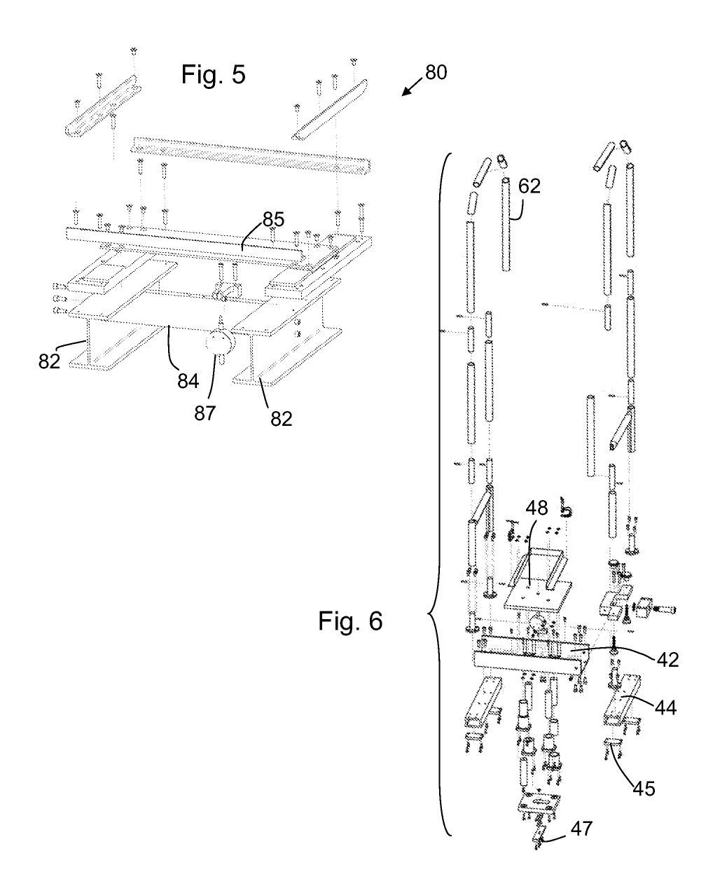

In order to verify operation of the apparatus for measuring deflection, and optionally to calibrate the measurements that are taken for an unknown load weight (for example if the operator's weight is not accurately known), a calibration fixture 80 can be provided as shown in FIG. 5. The calibration fixture 80 has a base that comprises spaced I-beams 82 coupled by a trestle 84, which holds the I-beams rigidly at a given spacing. A resiliently deflectable reference strip 85 is affixed to the upper flanges of the I-beams and extends over a free span over the trestle. The reference strip 85 can be a stainless or spring steel metal strip, having a relatively constant elasticity. The apparatus 20 of the invention is applied by resting the legs and feet 44, 45 on the I-beams and applying the tup 47 to the midpoint of the reference strip 85 and applying the test load weight.

In FIG. 5, the calibration fixture has a measurement scale 87 that can be used to read out the deflection difference between loaded and rest states. The scale 52 of the measurement apparatus can be used instead to determine the deflection of the reference strip 85.

In the embodiments of FIGS. 1-3, the weight receiving platform 48 is coupled directly to the tup, on opposite sides of the platform, by a rigid connection comprising the shaft 49 extending through the bridge 42. The respective embodiments show that different arrangements are possible using such a direct coupling, including shafts, slides and bushings. It is also possible to envision an linkage of movable parts to transmit weight on the platform to weight on the tup, rather than a rigid connection.

The apparatus is useful to measure the bending deflection of a deck plank, especially after installation on joists. This can be a quality/safety assurance step. For example, the invention can be used to determine compliance with a structural standard (or an arbitrary requirement) such as the L/360 rule, generally providing that the vertical deflection of a deck plank under load must be less than one 360^{th} of the span between the support joists.

FIG. 6 is an exploded view showing the individual parts provided in a practical embodiment. In this arrangement, the platform comprises a plate having plural guide shafts (comparable to single shaft 49) that are guided on bushings through the bridge member 42. The legs 44 comprise square tubing and the feet 45 are pad-like spacers at the ends of the square tubing. The tup 47 comprises a contact plate carried on the guide shafts. The handles are constructed of attached tubular segments, for example swaged tubes that are telescoped together and attached with welds or fasteners. The particular part and fastener arrangements are shown but need not be discussed in detail.

The invention as discussed above, in particular together with a knowledge of the span between adjacent joists to which the planks are fastened and optionally knowledge of the plank width, enables a determination as a function of the weight, the span and the deflection of the plank, whether the deck meets certain predetermined loading criteria. Such loading criteria can be, for example, an L/360 standard at a given live load weight for a plank of a given width such as 200 lbs. per square foot. If a given deflection is measured under the weight of the operator (or some other known weight that is applied as a test load), a deflection at a nominal load can be inferred, at least over a deflection range in which the deflection of the plank has a known relation to load weight (e.g., a linear or spring-constant relationship). The deflection at nominal load such as a weight equal to the rated live load for the applicable area of plank, in that case produces a deflection in a ratio to the observed deflection under the operator's weight, that is in the same ratio as the ratio of the respective weights of the operator and the rated live load.

In order to employ the invention for assessing compliance with such standards, and assuming that a range of different spans between joists and other particular deck characteristics are encountered, it is advantageous of if the invention is provided as a kit for assessing deflection of installed decking under load. The kit includes a span measuring device for determining a span distance between the spaced supports along a line parallel to elongation of a subset of planks, and for indicating said distance, together with the deflection measuring device for determining displacement of the subset of planks between at least two measurements taken in a direction perpendicular to said line parallel to elongation of the subset of planks at a point between the spaced supports, namely with and without the applied loading weight. The deflection measuring device comprises the elements discussed above.

The said span measuring device as discussed and shown in FIG. 4 can comprise an adjustable rule configured to extend between adjacent joists or similarly spaced supports, with a graduation scale indicating the span distance. A more conventional rule likewise can be used to “eyeball” the measurement between the lines of screws or other fasteners 28 (see FIG. 1). Preferably, the rule is useful from the top side of the deck and measures the unsupported span between supports on the underside. For this purpose, the adjustable rule having relatively spaced feeler ends as shown in FIG. 4, dimensioned to fit through a slot between adjacent planks, is convenient for determining the span distance as a distance between adjacent spaced supports to which the planks are fastened.

Another element of the kit can be the calibration reference, with a test member that deflects upon application of a load, wherein the calibration reference is configured to engage with the deflection measuring device in lieu of the subset of planks. The calibration as discussed and shown in FIG. 5 can include an elongated beam supported at spaced points, the beam having a known deflection with loading, and wherein the calibration reference is configured for engagement by the tup to receive the loading force, whereby accuracy of deflection measurements can be verified.

The invention has been disclosed in connection with a number of examples and preferred arrangements. However the specific examples should not be regarded as limiting and reference should be made to the appended claims rather than the foregoing specification to determine the scope of the invention and the scope of exclusive rights claimed.

We claim:

1. An apparatus for assessing deflection of installed decking under load, the decking having planks independently carried on spaced supports, the apparatus comprising:
a bridge member forming a chassis;
a support for the bridge member having a set of support legs arranged to carry the bridge member on the decking apart from a subset of planks, the legs holding at least part of the bridge member at a space over the subset of planks;
a tup movably mounted on the bridge member and extending downward to the decking, the tup being dimensioned exclusively to contact said subset of said planks;
a mechanism coupled to the tup for selectively applying a loading force to the subset of planks via the tup; and,
a displacement scale associated with the tup, having a reference reading absent the loading force and a deflection reading when the loading force is applied, a difference in said readings representing deflection of the subset of planks.

2. The apparatus of claim 1, wherein the subset of planks comprises a single plank that is straddled by the legs.

3. The apparatus of claim 1, wherein the apparatus is portable and the mechanism for selectively applying said loading force to the subset of planks comprises a platform rigidly coupled to the tup and movable toward and away from the decking, the platform being configured for temporary placement of a weight for selective application of the loading force.

4. The apparatus of claim 3, wherein the platform is configured to accommodate a human operator on the platform and a weight of said operator is applied as the loading force.

5. The apparatus of claim 1, further comprising at least one handhold rigidly affixed to the bridge and extending upwardly, by which the apparatus can be lifted and manually moved about, wherein a platform is disposed on an opposite side of the platform from the tup and is rigidly affixed to the tup by a shaft extending through the bridge, and wherein the platform is configured to allow a human operator to step onto the platform for selectively applying the loading force.

6. The apparatus of claim 1, wherein the displacement scale comprises a feeler gauge and further comprising an adjustment for zeroing the feeler gauge to establish the reference position.

7. The apparatus of claim 1, further comprising a calibration reference having an elongated beam supported at spaced points and having a known deflection with loading, wherein the calibration reference is configured for engagement by the tup to receive the loading force, whereby accuracy of deflection measurements can be verified.

8. The apparatus of claim 1, wherein the spaced supports are decking joists, and further comprising an adjustable rule configured to measure a span between the joists along a line parallel to elongation of the subset of planks.

9. The apparatus of claim 1, wherein the spaced supports are decking joists to which the planks are fastened, and wherein the bridge and the support are configured for placement of the tup at a midpoint between adjacent ones of the decking joists regardless of spacing and position of the decking joists, by supporting the bridge on at least one plank apart from a plank being tested.

10. A method for assessing deflection characteristics of installed planks in a deck, wherein the planks are supported independently on spaced joists, the method comprising:
supporting a bridge member exclusively on portions of the deck apart from at least one of the planks to be tested so as to extend a portion of the bridge member over the at least one plank to be tested, and mounting on the bridge a mechanism having a plank-contact tup that is movable on the bridge toward and away from said at least one plank at a space from the joists;
providing a measurement scale for determining displacement of the tup from a rest position against said plank;
applying a weight to press the tup against the plank, thereby applying a load to the plank at said space from the joists;
determining from the measurement scale a deflection of said plank under the load.

11. The method of claim 10, further comprising moving the bridge member to at least one other position on the deck, applying the load to an other plank at said other position and noting a deflection of said other plank.

12. The method of claim 11, wherein moving the bridge member includes a user manually manipulating the bridge member using at least one protruding handle.

13. The method of claim 12, wherein applying said weight comprises placing at least part of a weight of the user on a platform mechanically coupled to the tup.

14. The method of claim 10, further comprising calibrating the measurement scale by providing a portable deflection measurement reference standard having a bendable member simulating deflection of the plank, and applying the tup against the reference standard.

15. The method of claim 10, further comprising determining a span between adjacent joists and determining as a function of the weight, the span and the deflection of the plank, whether the deck meets predetermined loading criteria.

16. A kit for assessing deflection of installed decking under load, the decking having planks independently carried on spaced supports, comprising in combination:
a span measuring device for determining a span distance between the spaced supports along a line parallel to elongation of a subset of planks, and for indicating said distance;
a deflection measuring device for determining displacement of the subset of planks between at least two measurements taken in a direction perpendicular to said line parallel to elongation of the subset of planks at a point between the spaced supports, the deflection measuring device comprising: a bridge member forming a chassis; a support for the bridge member having a set of support legs arranged to carry the bridge member on the decking apart from the subset of planks, the legs holding at least part of the bridge member at a space over the subset of planks; a tup movably mounted on the bridge member and extending downward to the decking, the tup being dimensioned exclusively to contact said subset of said planks; a mechanism coupled to the tup for selectively applying a loading force to the subset of planks via the tup; and, a displacement scale associated with the tup.

17. The kit of claim 16, wherein said span measuring device comprises an adjustable rule configured to extend between adjacent said spaced supports, and a graduation scale indicating said span distance.

18. The kit of claim 17, wherein the adjustable rule comprises relatively spaced feeler ends dimensioned to fit through a slot between adjacent planks for determining the span distance as a distance between adjacent spaced supports to which the planks are fastened.

19. The kit of claim 16, further comprising a calibration reference comprising a test member that deflects upon application of a load, wherein the calibration reference is configured to engage with the deflection measuring device in lieu of the subset of planks.

20. The kit of claim 19, wherein the calibration reference comprises an elongated beam supported at spaced points, the beam having a known deflection with loading, and wherein the calibration reference is configured for engagement by the tup to receive the loading force, whereby accuracy of deflection measurements can be verified.
